(19) United States
(12) Patent Application Publication
(10) Pub. No.: US 2012/0106209 A1
(43) Pub. Date: May 3, 2012

(54) METHOD FOR GENERATING A CURRENT LIMIT SIGNAL FOR A POWER CONVERTER WITHOUT SENSING AN INPUT VOLTAGE OF THE POWER CONVERTER

(75) Inventors: Hsin-Yi WU, Taipei City (TW); Chih-Feng HUANG, Hsinchu County (TW)

(73) Assignee: RICHPOWER MICROELECTRONICS CORPORATION, Grand Cayman (KY)

(21) Appl. No.: 13/284,258

(22) Filed: Oct. 28, 2011

(30) Foreign Application Priority Data
Oct. 28, 2010 (TW) 099136972

(51) Int. Cl. H02M 3/335

(52) U.S. Cl. 363/21.18

(57) ABSTRACT

A method for generating a current limit signal for a power converter without sensing an input voltage of the power converter detects a current of a power switch of the power converter to obtain a current sense signal, counts a time for the current sense signal to increase from a first level to a second level, and according to the time, determines a current limit signal for limiting a maximum value of the current of the power switch for the power converter to have a constant maximum output power.

### FIELD OF THE INVENTION

The present invention is related generally to a power converter and, more particularly, to a method for generating a current limit signal for a power converter without sensing an input voltage of the power converter.

### BACKGROUND OF THE INVENTION

As shown in FIG. 1, a typical power converter includes a transformer 12 having a primary coil Lp and a secondary coil Ls, a power switch Q1 serially connected to the primary coil Lp, a current sense resistor Rs serially connected to the power switch Q1, and a controller 10 to provide a control signal PWM to control the power switch Q1 to convert an input voltage Vin into an output voltage Vo. The controller 10 detects the voltage across the current sense resistor Rs to obtain a current sense signal Vcs, which is related to the current Ip of the power switch Q1. Ideally, when the current sense signal Vcs reaches a preset current limit signal Vlimit, the controller 10 will turn off the power switch Q1 to limit the maximum value of the current Ip and thereby stabilize the load current Io. In other words, the on-time of the power switch Q1 is equal to the on-time of the control signal PWM and thus the power switch Q1 will have the current

Ip=(Vin/Lp)×Ton, [Eq-1]

where Ton is the on-time of the control signal PWM. According to the equation Eq-1, the power converter has the maximum output power

Po=0.5×(Lp/Ts)×Ip²=Vin²×Ton²/(2×Lp×Ts), [Eq-2]

where Ts is the switching period of the power switch Q1. As shown by the equation Eq-2, by controlling the maximum value of the current Ip, the power converter may have a stable maximum output power Po. Unfortunately, however, there is always a propagation delay Td from the time that the current sense signal Vcs reaches the current limit signal Vlimit to the time that the power switch Q1 turns off, as shown in FIG. 2. Therefore, the actual on-time of the power switch Q1 is equal to Ton+Td, and the equation Eq-2 should be revised into

Po=0.5×(Lp/Ts)×Ip²=Vin²×(Ton+Td)²/(2×Lp×Ts). [Eq-3]

Referring to FIG. 2, with the effect of the propagation delay Td, the actual peak value of the current sense signal Vcs is larger than the defined current limit signal Vlimit. On the other hand, different levels of the input voltage Vin will lead to different slopes and peak values of the current sense signal Vcs. As shown by the waveform 14 of FIG. 2, when the input voltage Vin is higher, the current sense signal Vcs increases with a steeper slope. Contrarily, as shown by the waveform 16 of FIG. 2, when the input voltage Vin is lower, the current sense signal Vcs increases with a flatter slope. Since the propagation delay Td is constant, the peak value of the current sense signal Vcs under a higher input voltage Vin will be larger than that under a lower input voltage Vin. Because the peak value of the current sense signal Vcs varies with the input voltage Vin, the peak value of the current Ip also varies with the input voltage Vin. Furthermore, the equation Eq-3 shows that variation of the peak value of the current Ip will induce an unstable maximum output power Po of the power converter. For preventing the foregoing problems, the controller 10 has an input terminal IN connected to the power input terminal Vin of the power converter through a resistor Ri to sense the input voltage Vin. The controller 10 will adjust the current limit signal Vlimit depending on the sensed input voltage Vin for the peak value of the current Ip to be independent of the input voltage Vin.

However, in the above method for sensing the input voltage Vin, the resistor Ri always results in power loss, particularly in a significant level when the input voltage Vin is high. In order to reduce this power loss, many methods have been proposed to extract an input voltage information to adjust the current limit signal Vlimit without sensing the input voltage Vin. For example, U.S. Pat. Nos. 6,674,656 and 7,643,313 guess the level of the input voltage Vin by using the on-time of the control signal PWM, for adjusting the current limit signal Vlimit accordingly. U.S. Pat. No. 7,616,461 detects the difference of the current sense signal Vcs between two preset time points to guess the slope of the current sense signal Vcs, to further guess the level of the input voltage Vin for adjusting the current limit signal Vlimit accordingly.

### SUMMARY OF THE INVENTION

An objective of the present invention is to provide a method for generating a current limit signal for a power converter without sensing an input voltage of the power converter.

According to the present invention, a method for generating a current limit signal for a power converter without sensing an input voltage of the power converter includes the steps of detecting a current of a power switch of the power converter to obtain a current sense signal, counting a time where the current sense signal increases from a first level to a second level, and according thereto, determining a current limit signal for limiting a maximum value of the current of the power switch for the power converter to have a stable maximum output power.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is a circuit diagram of a typical power converter;

FIG. 2 is a waveform diagram of a current sense signal under different levels of an input voltage;

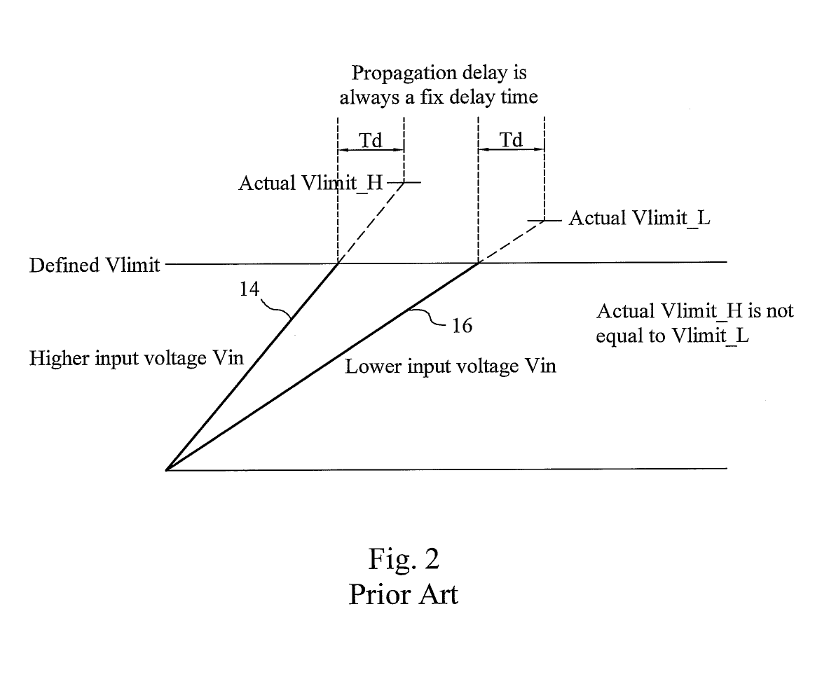

FIG. 3 is a flowchart of a method for generating a current limit signal for a power converter according to the preset invention;

FIG. 4 is a circuit diagram of a power converter using the method shown in FIG. 3;

FIG. 5 is a waveform diagram of a current sense signal to show the times that the current sense signal increases from a first level to a second level under different levels of an input voltage;

FIG. 6 is a diagram showing a relationship curve between a current limit signal and time; and

FIG. 7 is a waveform diagram of the current sense signal shown in FIG. 4 under different levels of an input voltage.

### DETAILED DESCRIPTION OF THE INVENTION

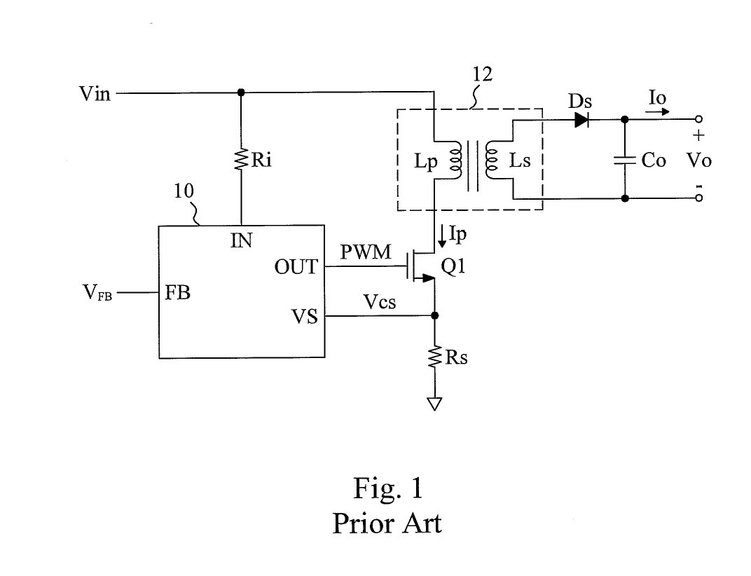

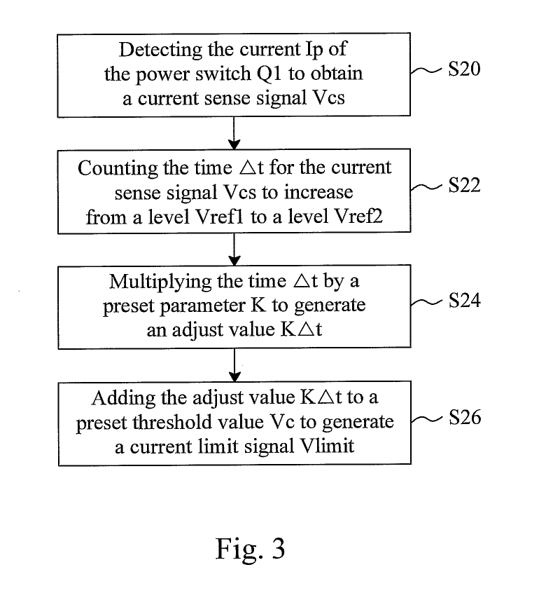

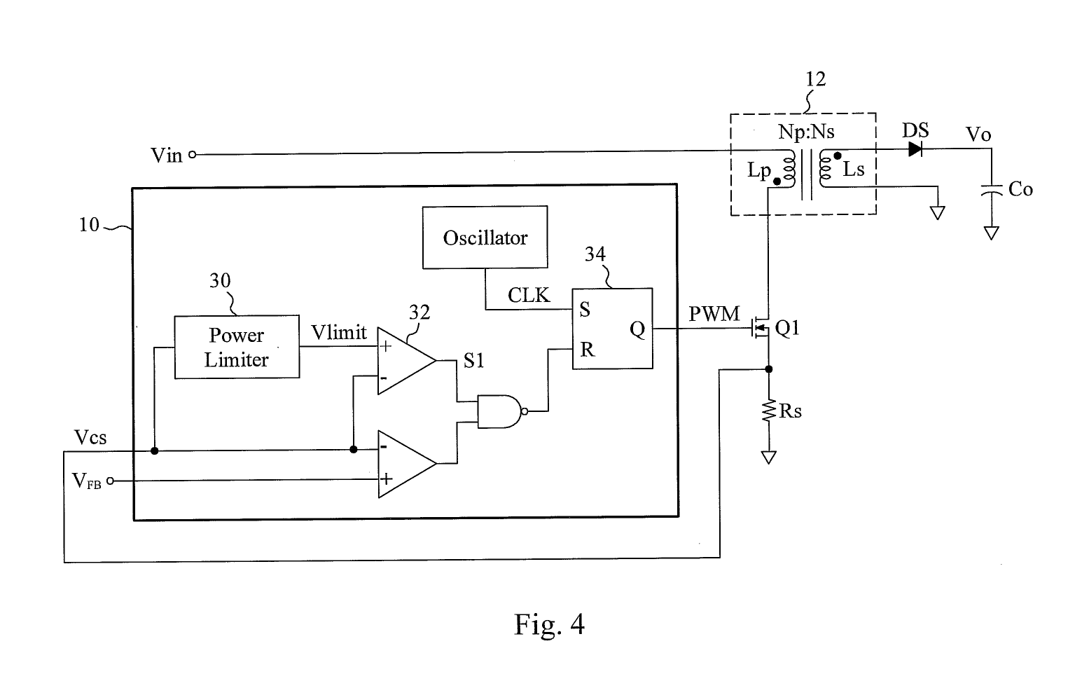

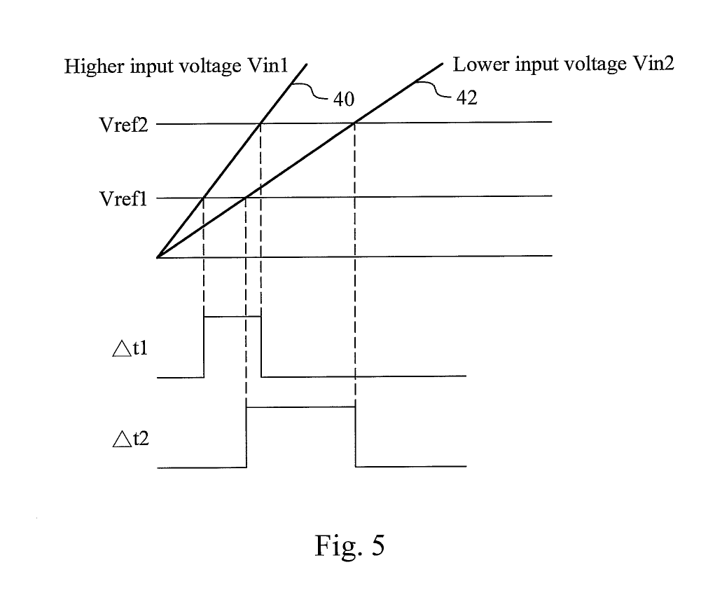

FIG. 3 is a flowchart of a method for generating a current limit signal for a power converter according to the preset invention, and FIG. 4 is a circuit diagram of a power converter using the method. In this embodiment, similar to the circuit of FIG. 1, the power converter includes the controller 10, the transformer 12, the power switch Q1 and the current sense resistor Rs, while the controller 10 does not sense the input voltage Vin. Instead, the controller 10 includes a power limiter 30 to determine a current limit signal Vlimit according to the current sense signal Vcs, a comparator 32 to compare the current sense signal Vcs with the current limit signal Vlimit to generate a comparison signal S1, and a flip-flop 34 to determine the control signal PWM according to a clock CLK and the comparison signal S1. As shown in FIG. 3, in step S20 the controller 10 detects the voltage across the current sense resistor Rs to detect the current Ip of the power switch Q1 to obtain the current sense signal Vcs related to the current Ip, and then in step S22, the power limiter 30 counts the time Δt for the current sense signal Vcs to increase from a level Vref1 to a level Vref2. As shown in FIG. 5, the current sense signal Vcs will have different slopes for different levels of the input voltage Vin. For a higher input voltage Vin1, as shown by the waveform 40, the current sense signal Vcs increases with a steeper slope, and hence the time Δt1 for the current sense signal Vcs to increase from the level Vref1 to the level Vref2 is shorter. Contrarily, for a lower input voltage Vin2, as shown by the waveform 42, the current sense signal Vcs increases with a flatter slope, and hence the time Δt2 for the current sense signal Vcs to increase from the level Vref1 to the level Vref2 is longer. In other words, the power limiter 30 can identify the slope of the current sense signal Vcs depending on the obtained time Δt, and thereby identify the level of the input voltage Vin. Therefore, the method according to the preset invention can detect the variation of the input voltage Vin without sensing the input voltage Vin.

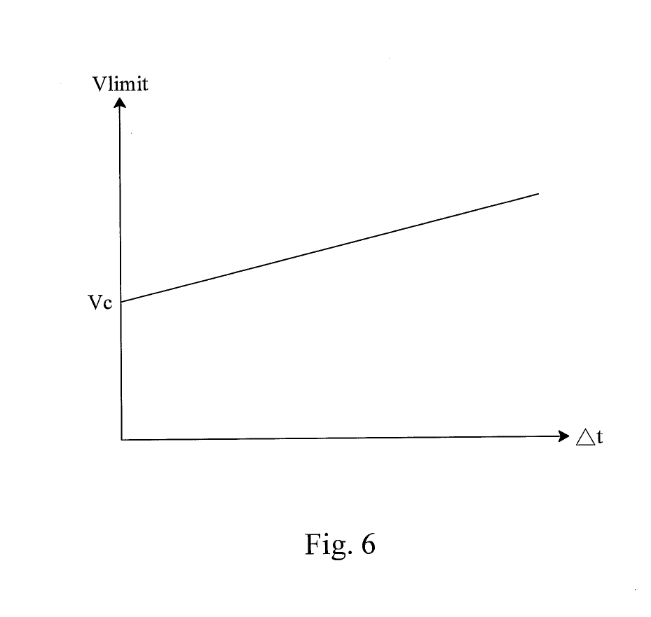

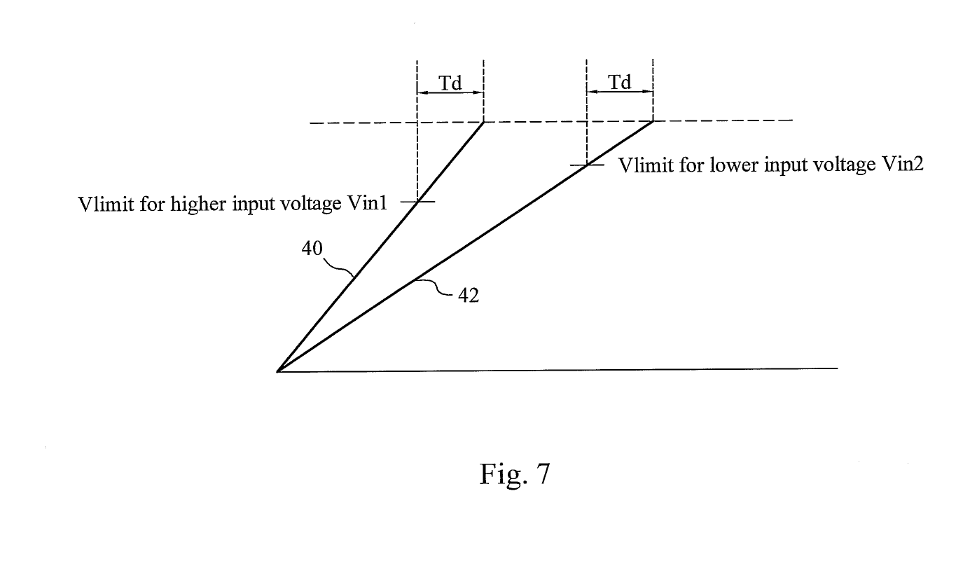

Afterward, in step S24, the power limiter 30 multiplies the obtained time Δt by a preset parameter K to generate an adjust value K×Δt, and in step S26, the power limiter 30 adds the adjust value K×Δt to a preset threshold value Vc to generate the current limit signal Vlimit=Vc+K×Δt. Since the parameter K and the threshold value Vc are constant, a relationship curve between the current limit signal Vlimit and the time Δt can be obtained as shown in FIG. 6. The relationship curve of FIG. 6 shows that when the time Δt increases, the current limit signal Vlimit increases correspondingly. That is, for a lower input voltage Vin2, as shown by the waveform 42 of FIG. 7, the power limiter 30 provides a higher current limit signal Vlimit, and contrarily, for a higher input voltage Vin1, as shown by the waveform 40 of FIG. 7, the power limiter 30 provides a lower current limit signal Vlimit. As a result, under different levels of the input voltage Vin, the current sense signal Vcs will have a constant peak value, thereby ensuring a stable maximum output power Po for the power converter.

Referring to FIG. 7 for derivation of the parameter K, since the peak value of the current sense signal Vcs is constant under different levels of the input voltage Vin and equal to the sum of the current limit signal Vlimit and a variation caused by the propagation delay Td, it will have the relationship

(Vc+K×Δt1)+[(Vin1/Lp)×Rs×Td]

=(Vc+K×Δt2)+[(Vin2 /Lp)×Rs×Td], [Eq-4]

and obtain the parameter

K=[(Vin2-Vin1)/(Δt1-Δt2)]×Rs×Td/Lp. [Eq-5]

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A method for generating a current limit signal for a power converter without sensing an input voltage of the power converter, the method comprising the steps of:
(A) detecting a current of a power switch of the power converter to obtain a current sense signal;
(B) counting an input voltage dependent time for the current sense signal to increase from a first level to a second level; and
(C) determining a current limit signal according to the input voltage dependent time for limiting a maximum value of the current of the power switch.

2. The method of claim 1, wherein the step C comprises the steps of:
multiplying the input voltage dependent time by a preset parameter to generate an adjust value; and
adding the adjust value to a preset threshold value to generate the current limit signal.
